(19) United States
(12) Patent Application Publication
(10) Pub. No.: US 2008/0122129 A1
(43) Pub. Date: May 29, 2008

(54) Embossing Device And A Method For Adjusting The Embossing Device

(76) Inventors: Pekka Koivukunnas, Jarvenpaa (FI); Raimo Korhonen, Tampere (FI); Markku Mantyla, Kangasala (FI); Antti Kemppainen, Oulu (FI); Juha Sumen, Kempele (FI)

Correspondence Address: VENABLE LLP, P.O. BOX 34385, WASHINGTON, DC, 20043-9998, US

(21) Appl. No.: 11/660,033

(22) PCT Filed: Aug. 5, 2005
(86) PCT No.: PCT/FI05/50288

§ 371 Date: Sep. 24, 2007

(30) Foreign Application Priority Data
Aug. 13, 2004 (FI) 20045295

(51) Int. Cl. B29C 59/02; B32B 38/06

(52) U.S. Cl. 264/1.34; 425/135

(57) ABSTRACT

A micro-optical grid structure is produced on a surface layer of a substrate by an embossing device and method. The embossing device includes an embossing member and a backing member, a temperature adjuster for adjusting the embossing temperature and a pressure adjuster for adjusting the pressure exerted by the embossing member and the backing member to the surface layer of the substrate. An optical measuring device is arranged to produce a diffraction signal dependent on the intensity of light diffracted from the surface of the substrate. The embossing pressure and/or temperature is/are adjusted on the basis of the diffraction signal to produce an optimal and even pattern depth of the grid structure. With the adjustment based on the diffraction signal, it is possible to avoid the sticking of the surface of the substrate to the embossing member due to too high an embossing temperature. When the pattern depth is optimal, collapse of the substrate caused by the too high embossing pressure is avoided.

The present invention relates to an embossing device for producing a micro-optical grid structure on the surface layer of the substrate, which embossing device comprises an embossing member, a backing member, at least one temperature adjustment means for adjusting the embossing temperature and/or at least one pressure adjustment means for adjusting the pressure exerted by the embossing member and backing member on the surface layer, and at least one optical measuring device. The present invention relates also to a method for adjusting said embossing device.

### BACKGROUND OF THE INVENTION

Micro-optical grid structures may be attached to products for the visual effect given by them, or in order to authenticate the product. The grid structures may be produced e.g. by embossing the surface layer of a substrate, which has been coated with a suitable lacquer. A coated substrate is pressed between an embossing member and a backing member in the embossing process. The embossing member is a mould having a relief corresponding to the grid structure. The backing member is a support, which supports the substrate from the back side during the embossing process such that a sufficient pressure, the embossing pressure, may be exerted on the substrate for shaping the surface to correspond to the relief of the embossing member. It is advantageous for the shaping of the surface of the substrate if the surface layer is plasticized by heating. This is typically performed by heating the coating and/or the embossing member. The temperature of the surface during the embossing process is herein called the embossing temperature. The embossing temperature is dependent both on possible pre-heating of the surface and on the temperature of the embossing member.

U.S. Pat. No. 4,913,858 discloses a method for producing a grid structure on the surface layer of paper coated with a thermoplastic material. In the method the coating is heated before the embossing to a temperature which is higher than the softening temperature. The grid structure is formed on the coating by means of a heated embossing roll, whose temperature is lower than said softening temperature. In the patent, suitable temperatures and pressing forces transmitted by the embossing roll are specified.

### SUMMARY OF THE INVENTION

The primary object of the present invention is to minimize operating problems in the embossing process. Another object of the present invention is to enable the production of micro-optical grid structures as economically as possible. Another purpose of the present invention is also to locally control the strength of the optical effect produced by the micro-optical grid structure at different points of the substrate.

To attain these objects, the device and method according to the invention are primarily characterized in what will be presented in the characterizing part of the appended independent claims. The dependent claims will present some preferred embodiments of the invention.

To attain these objects, the embossing device according to the invention and the method for adjusting the embossing device are primarily characterized in that at least one adjustment means for adjusting the embossing pressure and/or at least one adjustment means for adjusting the embossing temperature is adapted to be controlled on the basis of at least one diffraction signal, wherein said diffraction signal is dependent on the intensity of light diffracted from the surface of the substrate.

Said diffraction signal is dependent on the pattern depth of the produced grid structure, which, in turn, is dependent e.g. on the embossing pressure, embossing temperature, and the duration of the embossing pressure.

In view of a single spot on the embossed surface, the best possible quality is attained when the produced grid structure corresponds closely to the reliefs of the mould. Such a situation is attained for example when the embossing temperature is high, the embossing pressure is high and the embossing time is long. Such a situation is not, however, optimal in view of the process as a whole. If the embossing temperature is unnecessarily high, there is a risk that the surface to be embossed sticks to the embossing member. This causes clogging of the member or even a damage of the embossing member. By adjusting the embossing temperature according to the invention it is thus possible to avoid operating problems of the embossing device. If the embossing pressure is high, there is a drawback that the internal structure of the substrate is unnecessarily collapsed. Paperboard, for example, collapses or thermoplastic plastic may escape from between the mould and the backing member. On the other hand, if the embossing pressure or the embossing temperature is too low, the produced pattern depth may be small and the visual effect produced by the grid structure remains weak. Furthermore, if the embossing time is unnecessarily long, the production rate of the grid structure is thus not optimal.

The pattern depth produced by means of the embossing device is not always constant at different locations of the substrate, for example due to deflection of the embossing member. The local deviation in said pattern depth may be compensated automatically in certain embodiments of the present invention.

It is also possible that a weak effect is produced intentionally. This may be the aim if the substrate collapses easily or if it is desired to produce an imprint, which is nearly unnoticeable visually. Thus, it is important to control the produced pattern depth carefully.

The invention and its fundamental properties as well as the advantages to be attained by means of the invention will become more evident for a person skilled in the art from the claims and the following description, in which the invention will be described in more detail by means of a few selected examples.

### BRIEF DESCRIPTION OF THE DRAWINGS

FIG. 1 shows schematically the producing of a micro-optical grid structure on the surface layer of a substrate by embossing,

FIG. 2 shows schematically a micro-optical grid structure produced on the surface layer of a substrate, and an embossing member,

FIG. 3 shows an embossing device according to the present invention,

FIG. 4 shows an optical measuring device suitable for use in an embossing device according to the present invention,

FIG. 5 shows a schematic diagram of the adjustment method according to the invention, and

FIG. 6 shows an optical measuring device suitable for use in an embossing device according to the present invention, said optical measuring device further comprising light detectors used in stabilizing and/or calibrating of the measuring signal.

### DETAILED DESCRIPTION OF THE INVENTION

### First Embodiment

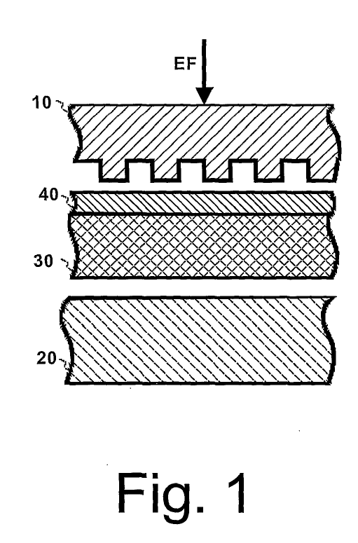

Referring to FIG. 1, a grid structure is produced on the surface layer 40 of a substrate 30 by pressing the substrate between an embossing member 10 and a backing member 20 such that the surface layer 40 of the substrate 30 is shaped to correspond to the relief on the surface of the embossing member 10. The substrate 30 may be e.g. paper, cardboard or plastic. The surface layer 40 of the substrate 30 may be e.g. a thermoplastic polymer, such as polyvinyl chloride, whose viscosity is reduced at high temperature. Examples of such materials are also listed in U.S. Pat. No. 4,913,858. The backing member 20 may be, for example, a rotating roll coated with hard rubber. The embossing member 10 may be, for example, a plate made of a nickel-based material, on which reliefs corresponding to the desired grid structure are produced by optical and electrolytic methods. A method for making such a plate is disclosed, for example, in U.S. Pat. No. 3,950,839. The plate is bent and welded to form a cylinder, which is placed on a roll arranged to be rotatable. Such a method for bending and welding a cylinder is disclosed for example in U.S. Pat. No. 6,651,338. The substrate 30 and its surface layer 40 are pressed during the rotation of the rolls such that a grid structure is formed on the surface layer.

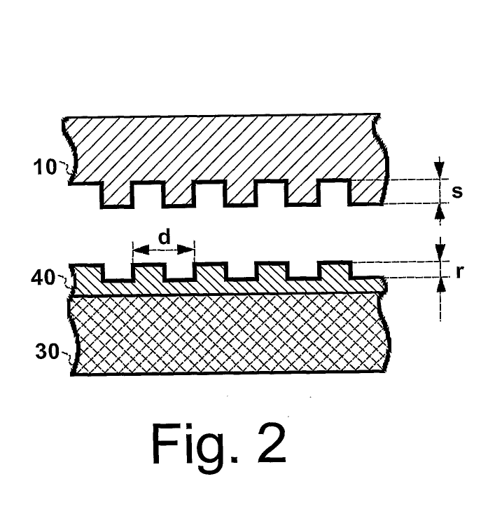

Referring to FIG. 2, the micro-optical grid structure embossed on the surface layer 40 of the substrate corresponds in its shape to the surface structure of the embossing member 10. The structure is periodical in such a manner that a substantially similar shape recurs at least in one direction on the surface at positions, which are separated by the so-called grating constant d. The value of the grating constant and the orientation of the shapes may vary in different locations of the surface, wherein the desired micro-optical effect or holographic pattern is obtained. For the produced grid structure it is possible to define the pattern depth r between the highest point and lowest point of the grid structure, which height is in a direction perpendicular to the surface. It is possible to determine a pattern depth s for the embossing roll, respectively. It should be noticed that highest possible value of r is equal to s, and in practice r is slightly smaller than s.

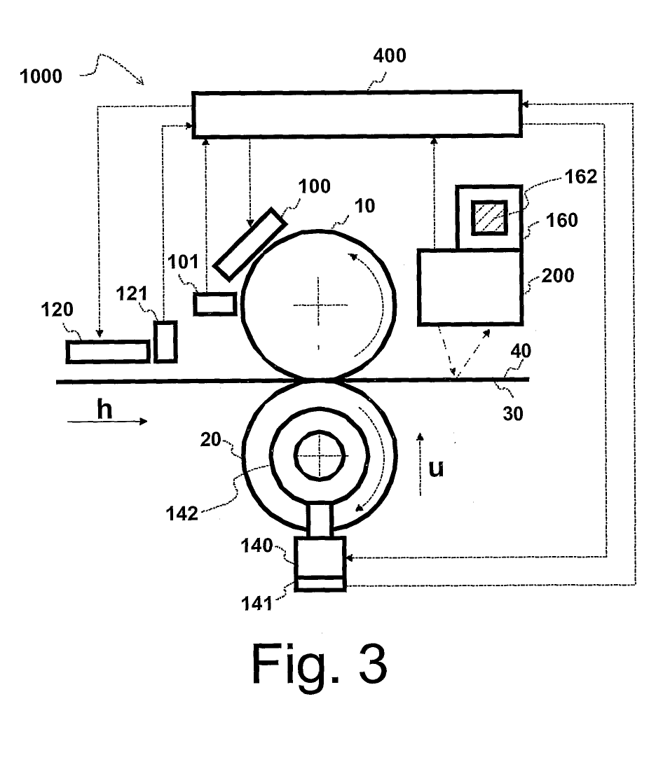

Referring to FIG. 3, the substrate 30 and its surface layer 40 are pressed between the embossing member 10 and the backing member 20 in the embossing device 1000. In the embodiment shown in FIG. 3, the embossing member and the backing member are rotating rolls. The embossing member 10 and the backing member 20 are rotated by rotation mechanisms whose speed of rotation is adjustable. Thus, the substrate 30 moves in a direction h and is pressed between the embossing member 10 and the backing member 20. The members 10, 20 or the rotating mechanisms have e.g. optical sensors for determining the angular position and the speed of rotation. The embossing temperature may be controlled by adjusting the power of infrared heaters 120 heating the surface layer 40 of the substrate 30 and/or by adjusting the power of inductive heaters 100 heating the embossing member 10. The heating of the embossing member 10 may also be based, in whole or in part, on the use of heat transfer media, such as hot oil. The temperatures are monitored, for example, by pyrometric measuring devices 101, 121.

The embossing pressure exerted by the embossing member 10 and the backing member 20 on the surface layer 40 of the substrate may be adjusted. The adjustment takes place, for example, by pressure adjustment means 140 coupled to the bearings 142 of the backing member 20, by which the backing member 20 may be moved in the direction u. Said pressure control means 140 may be e.g. one or more hydraulic or pneumatic cylinders 140. The cylinders 140 may be provided with sensors 141 for monitoring the embossing force, or indirectly also the embossing pressure.

At least one optical measuring device 200 is arranged to produce at least one diffraction signal 211 dependent on the intensity of light diffracted from the surface 40 of the substrate. The substrate may be so large that it cannot be monitored by the measuring device 200 at a time. The measuring device may thus be moved laterally by means of a transfer mechanism 160 along a guide 162, for scanning the whole width or area of the substrate.

A control unit 400 controls the temperature control means 100, 120 and/or the pressure control means 140 by so-called on-line adjustment on the basis of a diffraction signal 221 from the optical measuring device 200. Consequently, in the first embodiment, the arrangement for controlling the embossing pressure and/or the embossing temperature and comprising the optical measuring device 200 is feedback coupled; in other words, it forms a closed loop control circuit.

Measuring data from temperature sensors 101, 121 and other sensors, such as sensors 141 monitoring the embossing pressure are also utilized for the control.

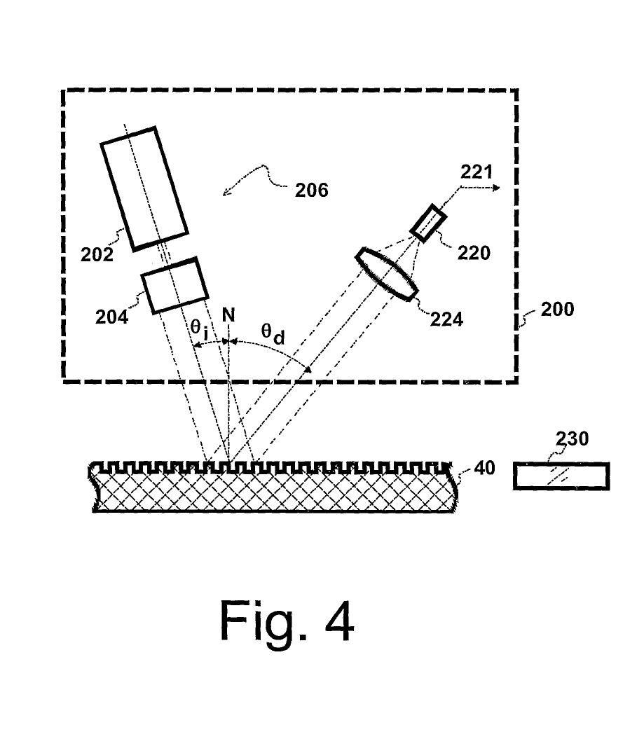

Referring to FIG. 4, the optical measuring device 200 comprises a light source 206 for illuminating the surface of the substrate 30 and a light detector 220 for determining the intensity of the diffracted light. The light-emitting element 202 of the light source 206 may be, for example, a laser. The light-emitting element 202 and the optical element 204 form together the light source 206. The light detector 220 may be, for example, a light diode. The light source 206 may comprise an optical element 204, for example a lens or a beam expander by which the light is directed to a target area having a desired size and shape. In certain situations it is possible to omit the optical element, for example when a HeNe laser is used as the light-emitting element 202. In connection with the light detector 220 there is an optical element 224, e.g. a lens for collecting light into the detector 220 from an area to be examined. Said optical element 224 defines together with the light detector 220 the direction and area of viewing for the detector. The optical element 224 collects diffracted light to the light detector 220, wherein the optical power collected on the active surface of the light detector is proportional to the intensity diffracted in the direction of viewing. The light detector 220 provides a signal 221 for the optical measuring device, which depends on the optical power collected to the light detector. The ratio between said signal 221 and the optical power is typically linear, but the dependency may also be non-linear. The illuminated area and/or the area to be examined may have for example a round or linear shape. It is obvious for the person skilled in the art that the measuring device 200 may be arranged such that predetermined finite ranges of angles are defined by the different directions of illumination and/or directions of viewing, wherein the signal 221 is produced as a sum of partial signals related to the different directions of illumination and the different directions of viewing.

The direction of illumination and the direction perpendicular to the surface of the substrate form the angle of illumination θₗ. The direction of viewing and the direction perpendicular to the surface of the substrate form the angle of viewing θ_{d}. The measuring device comprises means for setting the desired angle of illumination θₗ and the angle of viewing θ_{d}, irrespective of each other.

It is known that the intensity of diffracted light has a maximum at angles of illumination and viewing which fulfil the equation:

nλ=d(sinθ_{d}−sinθᵢ) (1)

where n is an integer indicating the order of diffraction and λ is the wavelength of light. The grating constant d was defined above.

It is advantageous to set the angle of illumination and the angle of viewing to meet the condition set by formula 1. It is particularly advantageous to set the angle of illumination θᵢ and the angle of viewing θ_{d} such that the equation 1 is fulfilled at values of n at −1 or 1 (the first diffraction order).

It is advantageous to examine the diffraction at narrow wavelength band. If required, the wavelength band may be limited by means of an optical filter, such as an interference filter arranged in connection with the light detector 220 of the light source 206 or the optical element 224.

The light source 206 and/or the light detector 220 is/are not necessarily stable. The measuring device is calibrated by arranging it to measure a reference surface 230. The reference surface 230 may be for example a white surface, partly light reflecting surface, for example a glass plate reflecting part of the light from its surface. The measuring device 200 may be moved to the position of the reference surface 230 or directed towards it. Alternatively, the reference surface 230 may be set to the area monitored by the measuring device 200. The reference surface 230 may also be set permanently to the beam of light provided by the light source 206, wherein the intensity of the beam of light reflected from the reference surface 230 is measured by means of a separate light detector to calibrate and/or stabilize the actual measuring signal 221.

In view of the calibration, it is advantageous if the signal obtained from the reference surface 230 is in the same order of magnitude as the signal 221 obtained from the produced grid structure in the actual measurement. For this reason it is advantageous to use a partly reflecting surface, for example a glass plate, as a reference surface 230. An interface between a glass plate and air reflects typically approximately 4% of light. To adjust the optical power levels, the measuring device may comprise automatically replaceable neutral density filters or automatically adjustable apertures.

It is also possible to use as a reference signal a signal which is produced when the angle of illumination θₗ and the angle of viewing θ_{d} are arranged to be equal. Thus, the diffraction in the so-called zeroth order is examined.

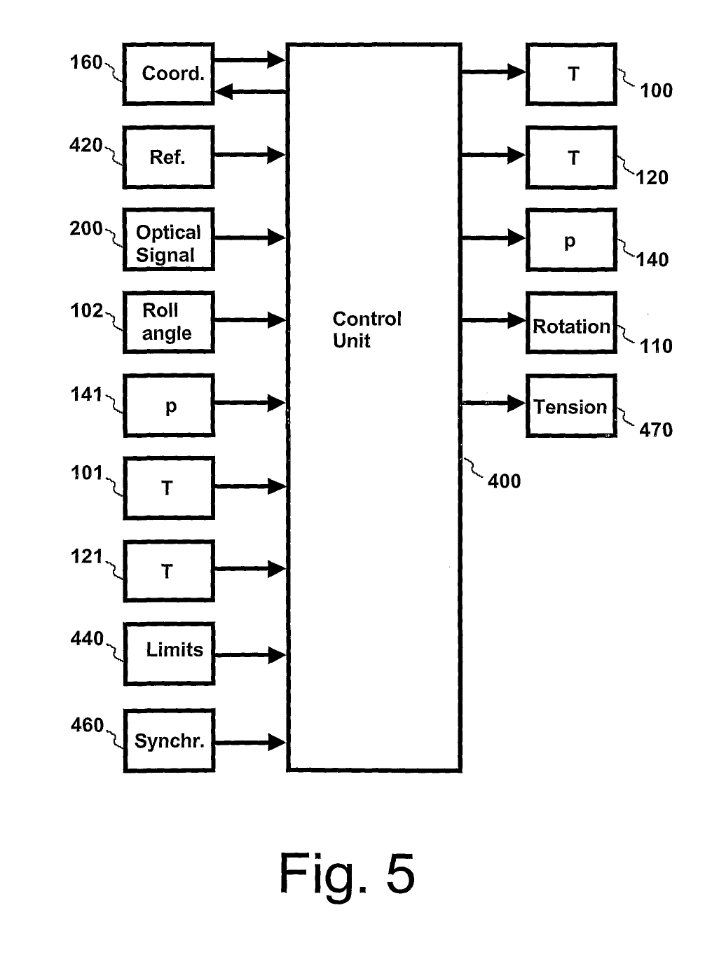

With reference to FIG. 5, the control unit 400 adjusts the values of temperatures, pressure and speed of rotation on the basis of the signal 221 of the optical measuring device 200. However, the control unit 400 does not necessarily control the embossing process directly, but communicates with separate control units for temperature, pressure, and rotating speeds to set target values. The control units adjust the actual values such that they correspond to the target values. The control unit 400 also communicates with other processes that are active simultaneously, such as a printing process or a coating process, to achieve problem-free cooperation. The control unit 400 also monitors the signals from various sensors and measuring devices. The control unit 400 takes also care of the protective measures of the system and alarms in failure situations.

The mechanism 160 for moving the optical measuring device 200 and the position sensor 102 of the embossing roll provide information about the position of the spot or the area of monitoring of the measuring device 200 in relation to the substrate. On the basis of the position, a relevant reference value is selected for the signal 221 from a reference value file 420. In the control unit 400, the signal 221 of the optical measuring device 200 is compared with the reference value. The reference value may be e.g. 90% of the signal level, which would be achieved if the pattern depth r of the microstructure would be exactly equal to the pattern depth s of the embossing member 10. For example, if the signal 221 from the measuring device 200 is higher than the target level, the temperature of the surface of the embossing member 10 is reduced. This may be achieved by reducing the heating power of the heating element 100 of the embossing member. A pyrometric temperature sensor 101 is also utilized for adjusting the temperature. Alternatively, it is also possible to increase the rotational speed of the rotation mechanism 110 of the embossing member, or to reduce the embossing pressure generated by the pressure adjustment means 140. It is also possible to use combinations of different control measures, for example both a change in the temperature and a change in the pressure. In the adjustment, information on the position and the speed of rotation, obtained from the position sensor 102 of the embossing member, and information from the sensors of the embossing pressure 141, which sensors are in connection with the hydraulic cylinders 140, is utilized. The temperature of the surface of the substrate may also be adjusted by utilizing the heating element 120 and the pyrometric temperature sensor 121.

However, it is not practical to exceed the certain limiting values of the parameters. Such limiting values include for example the temperature at which paper starts to darken, the temperature at which a chemical compound important for the properties of the coating starts to degrade, or the temperature at which it is known that it is very probable that the coating will stick to the embossing member. It is also possible to determine a limiting value for the pressure such that the substrate 30 and/or its surface layer 40 collapses or escapes from below the embossing member 10 at pressures higher than the limiting value. The limiting values may also be determined as boundaries of the parameter zones, wherein for example the limiting value of the embossing pressure is the function of the temperature and the embossing time. The limiting values are stored in a limit value file 440 where they are available to the control unit 400. The control unit 400 controls the embossing device in such a way that the limiting values are not exceeded.

### Further Embodiments

The embossing member 10 and the backing member 20 may be rotating cylinders or rolls. They may also be plate-like or curved members, wherein the movement of the embossing member 10 and/or the backing member 20 may be appropriately linear or curved.

It is possible to produce several zones comprising similar or different diffractive grid structures on the surface layer 40 of the substrate 30 to provide a desired colour effect, motion effect, two-dimensional pattern, pattern depending on the direction of viewing, animation, pattern providing a three-dimensional impression, or visually invisible microstructure. Part of the surface 40 may be left unembossed. The surface 40 may also comprise patterns or symbols produced with a dye by means of printing techniques. These may be produced before, simultaneously with or also after the embossing. The patterns provided with a dye and the produced grid structures may overlap partly.

The time during which pressure is exerted on the surface layer 40 of the substrate is adjusted by changing the speed of rotation of the rotating mechanism of the embossing member 10. This is not, however, possible if the embossing device 1000 is coupled to a printing machine. Thus, the aim is to produce the printed patterns and the grid structure exactly on correct locations in relation to each other and the produced substrate. Thus, it is said that the embossing device 1000 is in register with the printing machine. To attain this, the control unit 400 controls the speed of rotation of the embossing member 10 and/or tension of the substrate in the direction of the surface 40 e.g. by tensioning means 470 based on auxiliary rolls on either side of the embossing member 10 with respect to the travelling direction h of the substrate.

The synchronization of the printing process and the embossing process, i.e. their being in register is monitored for example by monitoring the position of the printed patterns in relation to the produced micro-optical grid structures by means of a machine vision system or optical sensors 460.

The surface layer 40 of the substrate may be, for example, made of a thermoplastic polymer, such as polyvinyl chloride or polystyrene. Alternatively, the surface layer 40 may consist of UV curable lacquer. The grid structure may also be embossed on printing ink as disclosed in U.S. Pat. No. 5,873,305. The substrate 30 and its surface layer 40 may consist entirely of the same material. The embossed surface layer 40 may be coated with a metal film to enhance the visual effect. The embossed surface layer 40 may be coated with a transparent protective film.

The thickness of the substrate 30 and/or the coating 40 may be monitored using a measuring device based on e.g. optical interference or triangulation. The control unit can thus take the rapid variations in the thickness of the substrate 30 into account in advance, and control the embossing pressure or the distance between the embossing member 10 and the backing member in a corresponding manner.

The measuring device may comprise several light sources 206 and/or several light detectors 220 which are used at different times or simultaneously in order to speed up the measuring process or in order to measure several signals 221 which signals are at least partly independent from each other. Similarly, it is possible to use several wavelengths λ.

It is possible to use several measuring devices 200 to examine the entire surface area or width of the surface 40 of the substrate. It is also possible to change the spot of monitoring by changing the direction of illumination and the direction of viewing by means of turning mirrors or by changing the orientation of the entire measuring device 200. The spot of monitoring may also be varied to a certain extent by moving the measuring device 200 in the direction of the normal N of the surface 40 of the substrate in an embodiment in which the angle of illumination θₗ and the angle of viewing θ_{d} are not equal.

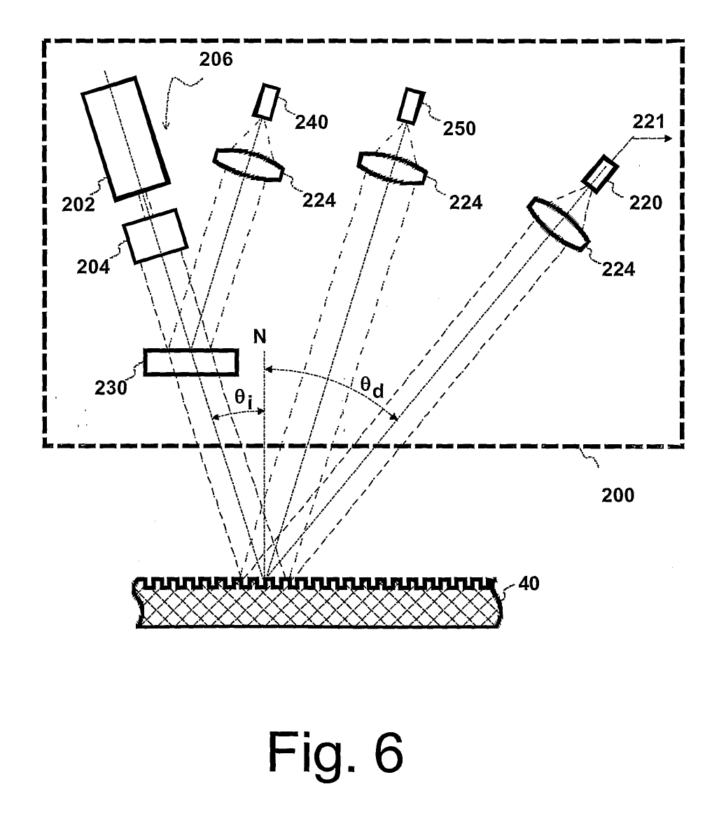

With reference to FIG. 6, the measuring device 200 may, in addition to the actual light detector 220, also comprise one or several further light detectors 240, 250 to produce signals used in the calibration of the measuring device 200. In the embodiment according to the figure, the light detector 240 is arranged to measure the intensity of light reflected from a reference surface 230, which is at least partly light-transmissive. By means of the light detector 240 it is possible to compensate at least the instability of the light source 206. A second light detector 250 may be arranged to measure the intensity of the diffraction in the zeroth order reflected from the surface 40. In addition to the actual light detector 220 the measuring device may also comprise either the light detector 240, the light detector 250 or both.

In an embodiment of the present invention the measuring device 200 is arranged to measure light diffracted to the order of zero. Thus, the angle of illumination θₗ and the angle of viewing θ_{d} are set to be equal. The basic principle of this embodiment is that when the diffraction efficiency in orders deviating from zero is increased, the diffraction efficiency in the order of zero is reduced in a corresponding manner. This embodiment is technically very simple and allows considerable positioning inaccuracy.

To select a correct reference value related to the measuring signal 221 of the measuring device 200 from the reference value file 420, it is possible perform the necessary identification of the examined position by means of the measuring signal 221. A change in the measuring signal 221 may be interpreted to mean e.g. that the edge of the grid structure is located at the viewing area of the measuring device 200.

The embossing pressure may be controlled for example by changing air pressure or oil pressure in the pressure control means affecting the backing member 20. Alternatively, the embossing pressure may be controlled by means of electromechanical servomechanisms. The embossing pressure is considered to be adjusted also when the distance between the embossing member 10 and the backing member 20 is primarily adjusted, because also in that case the embossing member produces pressure when the grid structure is formed.

The pressure adjustment means may affect the embossing member 10 instead of the backing member 20. Furthermore, the pressure adjustment means may affect both the embossing member 10 and the backing member 20.

The embossing device 1000 may also comprise heaters 100, 120 based on thermal radiation or auxiliary rolls heated by electricity or by a heat transfer medium. For monitoring the pressure and the temperature, the embossing member 10 and/or the backing member 20 may comprise thermoelements and pressure sensors. The heating of the surface 40 of the substrate may also be performed by utilizing hot air.

It is possible that the spatial distribution of the embossing pressure or temperature is not even at all different locations of the substrate 30. The embossing pressure may be uneven for example because of variations in the thickness of the substrate 30, or because of deflection of the embossing member 10 and/or backing member 20 resulting from the embossing pressure, gravitation or thermal expansion. Said distributions may be levelled by means of the measuring signal 221 produced by the measuring device 200. Thus, it is advantageous to arrange several separate pressure adjustment means 140, each of them affecting the embossing pressure primarily at a certain zone of the embossing member 10, which embossing pressure is exerted by the embossing member 10 on the surface layer 40 of the substrate 30. Thus, by adjusting the several pressure adjustment means 140 independently from each other it is possible to compensate the variations in the pattern depth r of the grid structure at different locations of the surface 40 of the substrate, resulting for example from the deflection of the embossing member 10 or variations in temperature. Thus, by means of the adjustment it is possible to affect the spatial distribution of the embossing pressure. For the corresponding reason, there should be preferably at least two or more independently adjustable heating elements 100, 120.

As an embodiment of the present invention, the adjustment of a deflection compensated roll on the basis of the measuring signal 221 of the measuring device 220 is presented in a situation where the embossing member 10 and the backing member 20 are rolls. The embossing roll 10 is pressed against the surface layer 40 of the substrate 30 substantially at the ends of the embossing roll 10, wherein the side of the embossing roll 10 on the substrate side becomes concave. To correct the uneven distribution of the embossing pressure resulting from the concave shape, the backing roll 20 or the embossing roll 10 may be deflection compensated, wherein the deflection compensation means that the central area of the roll exerts an embossing pressure on the surface layer 40 of the substrate 30 which is substantially equal to the embossing pressure exerted by the end areas of said roll.

For example, when the side of the embossing roll 10 on the substrate side 30 takes a concave shape under the effect of the embossing forces, the side of the backing roll 20 on the substrate 30 side is arranged to take a convex shape, in which case it is possible to produce a micro-optical grid structure having an even pattern depth r over the entire width of the surface 40 of the substrate. The pattern depth r of the micro-optical grid structure may thus be monitored by means of the measuring device 200, wherein it is possible to perform the necessary adjustment operations by means of the pressure control means 140 affecting the ends of the backing roll 20 or affecting inside the backing roll 20 to correct the shape of the rolls such that the spatial distribution of the embossing pressure is even or a desired one.

Ways of implementing a deflection compensated roll are disclosed in the patent application “Deflection compensated embossing device” filed simultaneously with the present application.

Alternative ways of implementing deflection compensated rolls are also disclosed for example in the book by Mikko Jokio: Papermaking Science and Technology, Part 3, Fapet Oy, 1999 (ISBN952-5216-10-1). There may several separately controlled zones in the rolls, wherein such a roll is also called a zone-controlled roll. In this context, zone-controlled rolls are also considered to be deflection compensated.

The light-emitting means 202 in the measuring device 200 may be for example a Helium-Neon-laser (HeNe laser), a semiconductor laser, a light-emitting diode (LED), an incandescent lamp, a halogen lamp, a metal vapor lamp, a fluorescent lamp, or a xenon lamp. It is also possible to use the light-emitting means 202 in a pulsed manner. The light detector 220 may be a photomultiplier tube, or alternatively a CCD (Charge Coupled Device) or CMOS (Complementary Metal Oxide Silicon) matrix. By means of matrix detectors it is possible to monitor several points on the surface of the substrate and/or to cover several illumination angles θₗ and/or viewing angles θ_{d} simultaneously.

There may be one or more light sources 206. There may also be one or several light detectors 220, wherein it is possible to monitor several diffraction orders simultaneously. Similarly, there may be one or several light-emitting elements in a single light source 206.

The optical elements 224 may comprise a lens, lenses or diffractive elements modifying the direction or shape of the light beam. In its simplest form the optical element 224 may also be a screen or a pinhole limiting the direction of illumination or the direction of viewing.

The light source 206 may also be arranged on a different side of the substrate than the light detector 220. This, however, requires that both the substrate 30 and the coating 40 are at least partly transparent.

The adjustments may be performed automatically such that the adjustment operations are carried out on the basis of the absolute value of the measuring signal 221, the relative variations of the measuring signal 221, or the difference between the measuring signal 221 and a reference value. The adjustments may be implemented using so-called PID control, whereby the adjustment is carried out on the basis of the difference between the real value and the target value, on the basis of the time integral of said difference, and/or on the basis of the time derivative of said difference.

Furthermore, the adjustment may be manual such that the user of the embossing device 1000 watches the signal 221 of the measuring device 200 or the a parameter computed from it using a display device, and performs the adjustment operation on the basis of the measuring signal 221, the relative variation in the measuring signal 221 or the difference between the measuring signal 221 and the reference value.

The adjustment means 100, 120, 140, 110 for pressure, temperature and speed of rotation may be provided with control circuits of their own such that the target values of pressure and temperature are changed on the basis of the measuring signal 221. Thus, separate control circuits adjust the actual values such that they correspond to the target values.

The control of the process may also take place on the basis of measuring signals, being based on the so-called fuzzy control.

By limiting the optical bandwidth of the light detector 220 and/or the direction of viewing of the light detector it is possible to attain the additional advantage that the measuring device 200 is thus less sensitive to backlight causing disturbances and reducing sensitivity. The thermal noise of the light detector 220 may be remedied in certain cases by cooling e.g. by the so-called Peltier element. To improve the tolerance of the light detector 220 to the disturbances, it is possible to modulate the intensity of light emitted from the light source 206 and to use phase-locked detection together with said modulation. The measuring device 200 may operate in such a hot environment that it is necessary to cool the measuring device 200. The cooling may be take place e.g. by blowing cooling medium or gas. The cooling may also be provided by a Peltier element. Elements resistant to thermal radiation may be positioned between the measuring device 200 and hot objects.

There may also be a device, such as a camera for monitoring the printed patterns and marks in connection with the measuring device 200. Thus, it is also possible to monitor the quality of the printing work in connection with the measurement.

In connection with the measuring device 200 there may also be an arrangement by means of which it is possible to measure the light transmittance of the substrate 30 and its surface layer 40. It is possible that in connection with the embossing, as a result of too high a temperature or pressure, coating material penetrates into the pores of the substrate 30. The impregnation of the substrate 30 partly or entirely with lacquer changes the light transmittance of the substrate 30. Thus, the information on the light transmittance complements to the controlling of the embossing process.

In addition to the adjustment of embossing temperature, embossing pressure, embossing time and register, the measuring device 200 may also be applied to the monitoring of the quality of the produced grid structure, for example according to the teachings of patent publication JP2000131244. Thus, it is for example possible to detect distinctively defective grid structures.

The measuring signal 221 of the measuring device 200 may also be used for monitoring the cleanness of the surface of the embossing member 10. If the signal 221 deviates significantly from the target value at a predetermined value of the embossing pressure and embossing temperature, this may be interpreted in certain cases to mean that the surface of the embossing member 10 has become unclean. If the measuring signal 221 does not correspond to the performed adjustment operations as expected, this may in certain cases be interpreted to mean that the surface of the embossing member 10 has become unclean. Furthermore, in the case of a rotating embossing member 10, a periodical variation of the signal 221 indicates that the embossing member 10 has become at least partly unclean. To detect the periodical variations it is possible to perform for example a Fourier transform of the measuring signal 221 with respect of time.

It is also possible to monitor the condition or the clogging of the embossing member directly, if the measuring device 200 is directed to monitor the surface of the embossing member 10 directly, instead of the surface of the substrate 40.

The invention is not limited solely to the embodiments presented in the above description or in the drawings. The aim is to limit the invention only by the presentation of the scope of the appended claims.

1-29. (canceled)

30. An embossing device for producing a micro-optical grid structure on the surface layer of a paper or cardboard substrate, local values of the grating constant of said grid structure being selected to provide a holographic pattern, said embossing device comprising:
an embossing member;
a backing member;
at least one temperature adjustment means for adjusting the embossing temperature and/or at least one pressure adjustment means for adjusting the embossing pressure exerted by the embossing member and the backing member on the surface layer; and
at least one optical measuring device arranged to produce at least one diffraction signal, wherein said diffraction signal depends on the intensity of light diffracted from said surface of the substrate, wherein said at least one pressure adjustment means and/or said at least one temperature adjustment means is arranged to be controlled on the basis of said at least one diffraction signal.

31. The embossing device according to claim 30, wherein the duration of the embossing pressure exerted on said surface layer is arranged to be adjusted on the basis of said at least one diffraction signal.

32. The embossing device according to claim 30, wherein at least one of said at least one diffraction signals is dependent on the intensity of light diffracted in the diffraction order of one or minus one.

33. The embossing device according to claim 30, wherein at least one optical measuring device is arranged to be calibrated by using an additional signal, said additional signal being dependent on the intensity of light diffracted from said surface layer in the order of zero.

34. The embossing device according to claim 30, wherein at least one of said at least one diffraction signals is dependent on the intensity of light diffracted to the diffraction order of zero.

35. The embossing device according to claim 30, wherein in said at least one optical measuring device at least one laser is adapted to operate as a light-emitting means.

36. The embossing device according to claim 30, wherein said at least one optical measuring device is movable in order to monitor different positions of said surface layer of the substrate.

37. The embossing device according to claim 30, wherein said at least one optical measuring device is arranged to be calibrated and/or stabilized by using at least one reference surface.

38. The embossing device according to claim 37, wherein the surface material of said reference surface is at least partly light-reflecting.

39. The embossing device according to claim 37, wherein said reference surface comprises a micro-optical grid structure.

40. The embossing device according to claim 37, wherein said embossing member and said backing member are rolls.

41. The embossing device according to any claim 37, wherein said embossing member and/or said backing member are/is deflection compensated.

42. The embossing device according to claim 37, wherein the spatial distribution of the embossing pressure exerted on said surface layer of the substrate is arranged to be adjusted using at least two separate pressure adjustment means.

43. The embossing device according to claim 37, wherein the position of said produced grid structure in relation to said substrate or patterns and marks produced on its said surface layer by means of printing methods is arranged to be adjusted on the basis of a diffraction signal produced by at least one optical measuring device.

44. The embossing device according to claim 37, wherein said at least one optical measuring device is arranged to monitor the cleanness of the surface of said embossing member.

45. A method for producing a micro-optical grid structure on the surface layer of a paper or cardboard substrate, local values of the grating constant of said grid structure being selected to provide a holographic pattern, said method comprising:
exerting embossing pressure on said surface layer of the substrate using an embossing member and a backing member, at least one optical measuring device being arranged to produce at least one diffraction signal, and said diffraction signal being dependent on the intensity of light diffracted from said surface of the substrate; and
controlling on the basis of said at least one diffraction signal at least one adjustment means for adjusting at least the embossing pressure exerted on said surface layer of the substrate and/or at least one temperature adjustment means for adjusting the embossing temperature.

46. The method according to claim 45 comprising adjusting the duration of the embossing pressure exerted on said surface layer on the basis of said at least one diffraction signal.

47. The method according to claim 45, wherein at least one of said at least one diffraction signals is dependent on the intensity of light diffracted from said surface layer in the diffraction order of one or minus one.

48. The method according to claim 45, comprising calibrating at least one optical measuring device by using a further signal, said further signal being dependent on the intensity of light diffracted from said surface layer in the order of zero.

49. The method according to claim 45, wherein at least one of said at least one diffraction signals depends on the intensity of light diffracted from said surface layer in the diffraction order of zero.

50. The method according to claim 45, wherein in said at least one optical measuring device at least one laser operates as a light-emitting means.

51. The method according to claim 45, further comprising:
moving said at least one optical measuring device in order to monitor different points on said surface layer.

52. The method according to claim 45, further comprising:
calibrating said at least one optical measuring device by using at least one reference surface.

53. The method according to claim 52, wherein the surface material of said reference surface is at least partly light-reflecting.

54. The method according to claim 52, wherein said at least one reference surface comprises a micro-optical grid structure.

55. The method according to claim 45, further comprising:
adjusting the spatial distribution of the embossing pressure exerted on said surface layer of the substrate by using at least two separate pressure adjustment means.

56. The method according to claim 45, wherein the pattern depth of the grid structure produced on said surface layer of the substrate is substantially smaller than the corresponding pattern depth of the embossing member.

57. The method according to claim 45, further comprising:
controlling the location of said produced grid structure in relation to said substrate or patterns and marks produced on said surface layer of the substrate by means of printing methods on the basis of a diffraction signal produced by means of at least one optical measuring device.

58. The method according to claim 45, further comprising:
monitoring the cleanness of the surface of said embossing member by means of at least one optical measuring device.
